(19) United States
(12) Patent Application Publication
(10) Pub. No.: US 2005/0271928 A1
(43) Pub. Date: Dec. 8, 2005

(54) Proton exchange membrane fuel cell with non-noble metal catalysts

(76) Inventors: Stanford R. Ovshinsky, Bloomfield Hills, MI (US); Srinivasan Venkatesan, Southfield, MI (US); Hong Wang, Troy, MI (US); Konstantin Petrov, Troy, MI (US); Kevin Fok, Tory, MI (US)

Correspondence Address: ENERGY CONVERSION DEVICES, INC., 2956 WATERVIEW DRIVE, ROCHESTER HILLS, MI, 48309, US

(21) Appl. No.: 10/862,513

(22) Filed: Jun. 7, 2004

(51) Int. Cl. H01M 4/90; H01M 8/10

(52) U.S. Cl. 429/40; 429/30

(57) ABSTRACT

A Proton Exchange Membrane fuel cell including a hydrogen electrode utilizing non-noble metal hydrogen oxidation catalysts, and/or an oxygen electrode utilizing non-noble metal oxygen reduction catalysts. The non-noble metal hydrogen oxidation catalysts and the non-noble metal oxygen reduction catalysts provide for a long catalyst cycle life due to increased stability and poisoning resistance in an acidic environment.

### FIELD OF THE INVENTION

The present invention generally relates to Proton Exchange Membrane type fuel cells. More specifically, the present invention relates to instant start-up Proton Exchange Membrane type fuel cells having hydrogen electrodes and/or oxygen electrodes incorporating non-noble metal catalysts.

### BACKGROUND

As the world's population expands and its economy increases, the atmospheric concentration of carbon dioxide is warming the earth causing climate change. However, the global energy system is moving steadily away from the carbon-rich fuels whose combustion produces the harmful gas. Experts say atmospheric levels of carbon dioxide may be double that of the pre-industrial era by the end of the next century, but they also say the levels would be much higher except for a trend toward lower-carbon fuels that has been going on for more than 100 years. Furthermore, fossil fuels cause pollution and are a causative factor in the strategic military struggles between nations. Furthermore, fluctuating energy costs are a source of economic instability worldwide.

In the United States, it is estimated, that the trend toward lower-carbon fuels combined with greater energy efficiency has, since 1950, reduced by about half the amount of carbon spewed out for each unit of economic production. Thus, the decarbonization of the energy system is the single most important fact to emerge from the last 20 years of analysis of the system. It had been predicted that this evolution will produce a carbon-free energy system by the end of the 21^{st} century. The present invention is another product which is essential to shortening that period to a matter of years. In the near term, hydrogen will be used in fuel cells for cars, trucks and industrial plants, just as it already provides power for orbiting spacecraft. But, with the problems of storage and infrastructure solved (see U.S. application Ser. No. 09/444,810, entitled “A Hydrogen-based Ecosystem” filed on Nov. 22, 1999 for Ovshinsky, et al., which is herein incorporated by reference and U.S. patent application Ser. No. 09/435,497, entitled “High Storage Capacity Alloys Enabling a Hydrogen-based Ecosystem”, filed on Nov. 6, 1999 for Ovshinsky et al., which is herein incorporated by reference), hydrogen will also provide a general carbon-free fuel to cover all fuel needs.

Hydrogen is the “ultimate fuel.” In fact, it is considered to be “THE” fuel for the future. Hydrogen is the most plentiful element in the universe (over 95%). Hydrogen can provide an inexhaustible, clean source of energy for our planet which can be produced by various processes. Utilizing the inventions of subject assignee, the hydrogen can be stored and transported in solid state form in trucks, trains, boats, barges, etc. (see the '810 and '497 applications).

A fuel cell is an energy-conversion device that directly converts the energy of a supplied gas, such as hydrogen, into an electric energy. Researchers have been actively studying fuel cells to utilize-the fuel cell's potential high energy-generation efficiency. The base unit of the fuel cell is a cell having an oxygen electrode, a hydrogen electrode, and an appropriate electrolyte. Fuel cells have many potential applications such as supplying power for transportation vehicles, replacing steam turbines, and power supply applications of all sorts. Despite their seeming simplicity, many problems have prevented the widespread usage of fuel cells.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources based upon the Carnot cycle.

The major components of a typical fuel cell are the hydrogen electrode and the oxygen electrode, both being positioned in a cell containing an electrolyte (such as an acidic or alkaline electrolytic solution). Typically, the reactants, such as hydrogen and oxygen, are respectively fed through a porous hydrogen electrode and oxygen electrode, dissociated into atomic hydrogen and atomic oxygen, and brought into surface contact with the electrolytic solution. The particular materials utilized for the hydrogen electrode and oxygen electrode are important since they must act as efficient catalysts for the reactions taking place.

Presently most of the fuel cell R & D focus is on PEM (Proton Exchange Membrane) fuel cells. A PEM fuel cell generally includes a hydrogen electrode, an oxygen electrode, and a proton exchange membrane. The hydrogen electrode and the oxygen electrode are separated by a proton exchange membrane which prevents the flow of electrons therethrough while allowing protons to flow therethrough from the hydrogen electrode to the oxygen electrode. In a PEM fuel cell, at the hydrogen electrode, hydrogen contacts the hydrogen electrode catalyst and is dissociated into atomic hydrogen thereby releasing electrons:
2H₂→4H⁺+4e⁻.
Upon being dissociated into atomic hydrogen at the hydrogen electrode, the atomic hydrogen passes through the proton exchange membrane and the electrons flow through an external circuit to the oxygen electrode. At the oxygen electrode, oxygen is dissociated into atomic oxygen in the presence of the oxygen electrode catalyst into atomic oxygen and reacts with hydrogen ions in the electrolyte to form water:
O₂+4H⁺+4e⁻→2H₂O.
The flow of electrons through the external circuit is utilized to provide electrical energy for a load externally connected thereto.

While the P.E.M fuel cell is becoming more and more prevalent in the alternative energy sectors, the PEM fuel cell currently suffers from relatively low conversion efficiency and has several other disadvantages. For instance, the electrolyte for the system is acidic. Thus, noble metal catalysts, such as platinum, have been the only useful active materials for the electrodes of the system. Unfortunately, not only are the noble metals costly, they are also susceptible to poisoning by many gases, such as carbon monoxide (CO), which substantially impede the performance and lifetime of the electrodes utilized in the fuel cells.

Non-noble metal catalysts, if developed and successfully substituted for the noble metal catalysts in PEM fuel cells, would have a dramatic effect on the marketability and acceptance of PEM fuel cells for everyday use. By using low cost catalytic materials which provide for high efficiency and high poisoning resistance, the cost of PEM fuel cells will be substantially reduced while providing for better performance ultimately resulting in utilization of PEM fuel cells in a wide variety of applications.

### SUMMARY OF THE INVENTION

The present invention discloses a PEM fuel cell comprising a hydrogen electrode comprising an anode active material including a non-noble metal hydrogen oxidation catalyst. The hydrogen electrode may be substantially free from any noble metal catalysts. The non-noble metal hydrogen oxidation catalyst may comprise a hydrogen storage alloy selected from Rare-earth metal alloys, Misch metal based alloys, zirconium based alloys, titanium based alloys, magnesium/nickel based alloys, tantalum based alloys, tungsten based alloys, and mixtures thereof. The hydrogen storage alloy may be at least partially coated with an acid resistant coating. The acid resistive coating may be selected from metals, metal oxides, metal carbides, nitrides, fluoropolymers, and mixtures thereof. The non-noble metal hydrogen oxidation catalyst may also comprise a high surface area carbide including at least one transition metal. Preferably, the high surface area carbide includes tungsten and/or molybdenum. The high surface area carbide preferably has a surface area of 150 m²/g to 300 m²/g.

The PEM fuel cell may further comprise an oxygen electrode comprising a cathode active material including a non-noble metal oxygen reduction catalyst. The oxygen electrode may be substantially free from any noble metal catalysts. The non-noble metal oxygen reduction catalyst may comprise a high surface area carbide including at least one transition metal. Preferably, the high surface area carbide includes tungsten and/or molybdenum. The high surface area carbide preferably has a surface area of 150 m²/g to 300 m²/g. The non-noble metal oxygen reduction catalyst may also comprise at least one metal oxide selected from perovskites, spinels, and pyrochlores. The perovskites have the formula A₁₋ₓA′ₓBO₃, wherein A is a lanthanide, A′ is an alkaline earth metal, and B is a first row transition metal. The pyrochlores have the formula A₂B₂₋ₓAₓOO′, wherein A is a rare earth element, Ti, Pb, or Bi, and B is a transition metal. The spinels have the formula AB₂O₄, wherein A is a nonmagnetic metal and B is a transition metal. The non-noble metal oxygen reduction catalyst may also comprise one or more titanium suboxides having the formula TiOₓ, wherein 0.65≦X≦1.25.

### BRIEF DESCRIPTION OF THE DRAWINGS

FIG. 1, is a depiction of an electrochemical cell unit of the PEM fuel cell in accordance with the present invention.

FIG. 2, is a depiction of a hydrogen electrode as used in the PEM fuel cell in accordance with the present invention.

FIG. 3, is a depiction of a oxygen electrode as used in the PEM fuel cell in accordance with the present invention.

### DETAILED DESCRIPTION OF THE PREFERRED EMBODIMENTS OF THE INVENTION

The present invention discloses a Proton Exchange Membrane (PEM) fuel cell incorporating hydrogen and oxygen electrodes utilizing non-noble metal catalysts. By using non-noble metal catalysts, the fuel cell in accordance with the present invention provides for a low cost alternative to the PEM fuel cells being currently used.

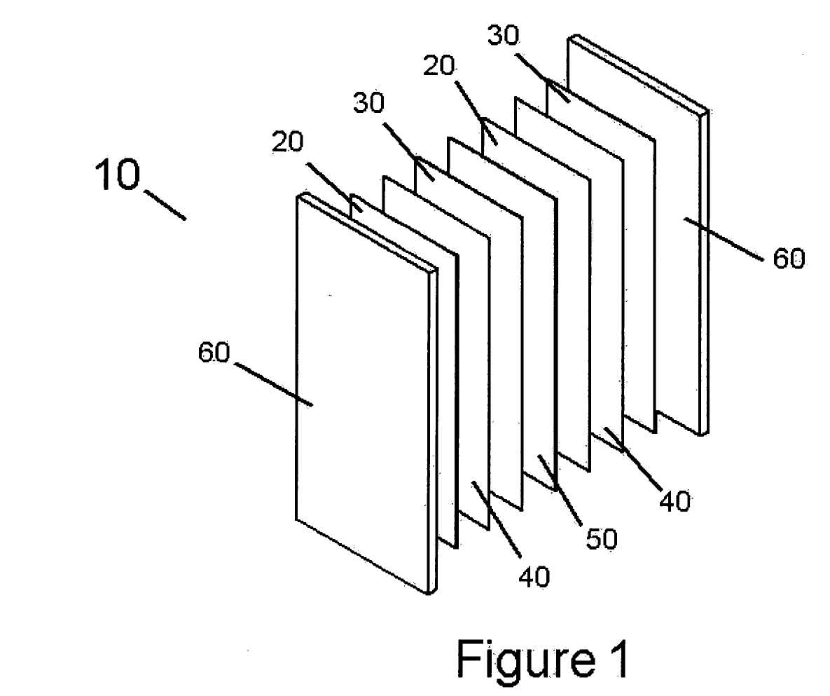

An embodiment of a PEM fuel cell in accordance with the present invention is shown in FIG. 1. The PEM fuel cell 10 comprises at least one hydrogen electrode 20 and at least one oxygen electrode 30. Each hydrogen electrode 20 has an electrolyte interface and a hydrogen interface and each oxygen electrode 30 has an electrolyte interface and an oxygen interface. The electrolyte interfaces of the hydrogen electrode 20 and the oxygen electrode 30 are in contact with and separated by a proton exchange membrane 40 formed from a solid acidic electrolyte. The proton exchange membrane 40 allows hydrogen atoms to flow through it, while preventing the flow of electrons therethrough. Where more than one hydrogen electrode and oxygen electrode is utilized, the PEM fuel cell may further comprise one or more bipolar plates 50 which provide electrical communication between the electrodes. The one or more bipolar plates 50 are disposed between each hydrogen electrode/oxygen electrode pair adjacent to the hydrogen interface of the hydrogen electrodes 20 and the oxygen interface of the oxygen electrode. The bipolar plates 50 may have a series of flow channels which provide pathways for the hydrogen and/or oxygen to contact the respective electrodes and aid in distribution of hydrogen and/or oxygen across the respective interfaces of the electrodes. Bipolar plates may also be shared between electrodes thereby reducing the number of bipolar plates in the PEM fuel cell. End plates 60 are disposed at the ends of each PEM fuel cell to maintain the structural integrity of the fuel cell.

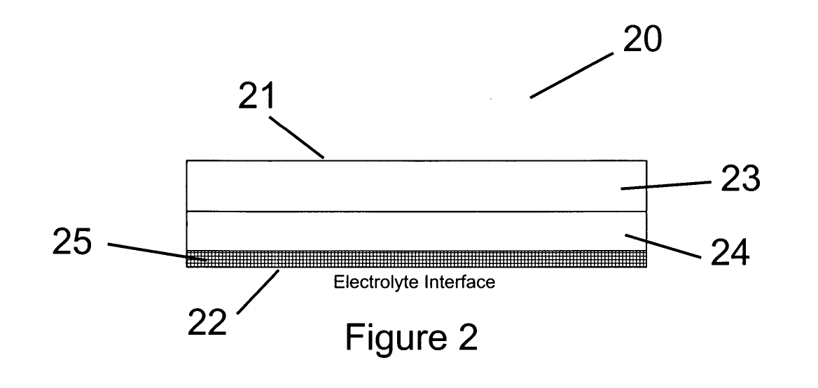

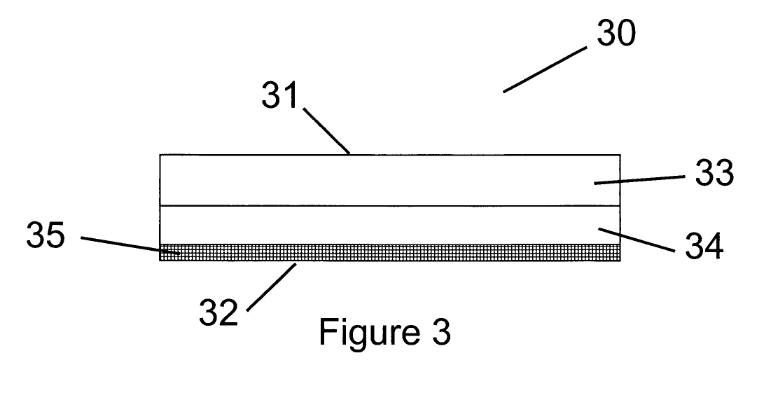

A depiction of a hydrogen electrode in accordance with the present invention is shown in FIG. 2 and a depiction of an oxygen electrode in accordance with the present invention is shown in FIG. 3. The hydrogen electrode 20 generally has a hydrogen contacting surface 21 and an electrolyte contacting surface 22 in contact with the proton exchange membrane 40, and the oxygen electrode 30 generally has an oxygen contacting surface 31 and an electrolyte contacting surface 32 in contact with the proton exchange membrane 40. The design of the electrodes may vary, provided the hydrogen and oxygen is allowed to contact the respective electrode, be dissociated into its atomic form, and contact the proton exchange membrane 40. The proton exchange membrane 40 may be comprised of Nafion® (Registered Trademark of Dupont) and/or modified polysulfonic acid based membrane. The proton exchange membrane 40 allows protons to flow through it from the hydrogen electrode 20 to the oxygen electrode 30 while forcing electrons to flow around it resulting in the formation of an external circuit. During operation, as hydrogen and oxygen are supplied to the respective electrodes, the hydrogen ions flow through the proton exchange membrane 40 and are reacted with atomic oxygen at the oxygen electrode 30 to form water, while the electrons flow from the hydrogen electrode 20 to the oxygen electrode 30 via an external circuit in electrical communication with a load. The proton exchange membrane may be formed from other types of solid electrolyte provided the solid electrolyte allows the flow of atomic hydrogen through the electrolyte from the hydrogen electrode to the oxygen electrode while preventing the flow of electrons therethrough.

The hydrogen electrode 20 is comprised of an anode active material comprising one or more non-noble metal catalysts. Preferably, the hydrogen electrode is substantially free from any noble metals as the inclusion of noble metals may substantially increase the cost of the fuel cell.

One type of non-noble metal catalyst catalytic toward the hydrogen oxidation reaction as used in the anode active material of the hydrogen electrodes of the present invention are hydrogen storage alloys. The hydrogen storage alloys may be acid resistant hydrogen storage alloys or conventional hydrogen storage alloys with an acid resistant coating. When utilized in the anode active material, the hydrogen storage alloys simultaneously absorb hydrogen on the gas interface of the hydrogen electrode and desorb hydrogen on the electrolyte interface of the hydrogen electrode. When hydrogen contacts the hydrogen interface 21 of the hydrogen electrode 20, it is dissociated and absorbed by the hydrogen storage alloy and temporarily stored in hydride form. The hydride is then electrochemically oxidized at the electrolyte interface yielding atomic hydrogen which flows through the proton exchange membrane to the oxygen electrode and electrons which flow through an external circuit to the oxygen electrode. By using hydrogen storage alloys, the need for an electro-catalyst other than the hydride is eliminated. In addition to acting as a catalyst for the hydrogen electrode, the hydrogen storage alloys act as insitu hydrogen storage devices. A finite capacity buffer of hydrogen is stored in the hydrogen storage alloy thereby enabling the fuel cell to have an instant start capacity. The acid resistant hydrogen storage alloys may be titanium based alloys, tantalum based alloys, or tungsten based alloys. These alloys may also include modifier elements which may increase stability, hydrogen storage kinetics, total hydrogen storage capacity, and reversible hydrogen storage capacity of the acid resistant hydrogen storage alloy. Certain metals, metalloids, or metal oxides may also be added to conventional hydrogen storage alloys to form acid resistant hydrogen storage alloys. Typical metalloids may be selected from elements such as boron and silicon. The conventional hydrogen storage alloys coated with an acid resistive layer may be selected from Rare-earth metal alloys, Misch metal alloys, zirconium alloys, titanium alloys, magnesium/nickel alloys, and mixtures or alloys thereof which may be AB, AB₂, or AB₅ type alloys. The conventional hydrogen storage alloys may also include modifier elements which may increase stability, hydrogen storage kinetics, total hydrogen storage capacity, and reversible hydrogen storage capacity of the acid resistant hydrogen storage alloy. The acid resistive coating may be comprised of metals, metal oxides, metal carbides, nitrides, fluoropolymers, or various other polymeric materials. While protecting the hydrogen storage alloy from the acidic environment, the coating allows hydrogen molecules to permeate through the coating and contact the hydrogen storage alloy. The choice of the coating will have to be such that the electrochemical oxidation of hydrogen at the electrolyte interface is facilitated by the alloy. Such a requirement may require the use of two coatings, one for the prevention of corrosion in the acidic environment and the other for catalysis. The coatings may be applied via spraying, sputtering, mechanical alloying, or other methods known in the art.

Another non-noble metal catalyst catalytic toward the hydrogen oxidation reaction as used in the anode active material of the hydrogen electrodes of the present invention may be high surface area carbides including Group IV to Group VIII transition metals. Certain transition metal carbides such as tungsten and molybdenum carbides are highly conductive, catalytically active, and stable in an acidic environment. The high surface carbides will be in the form of nano-particles with surface areas in the range of 150 to 300 m²/g. The high surface area carbides may also include modifier elements to improve performance. Carbides are among the most active hydrogenitrogenation and hydrogenolysis catalysts known, and their properties are similar to platinum group metal catalysts. Carbides are also sulfur tolerant. Most transition metal carbides are interstitial compounds. These compounds are characterized by the presence of small atoms such as carbon, nitrogen, boron, and/or oxygen in interstices in the metal lattice. As a consequence of the coexistence of covalent, metallic, and ionic bonding, many interstitial compounds possess unique physical, electronic, and chemical properties. The non-metal atoms and vacancies concentrations within the carbides can also significantly influence the catalytic activities of carbides. A number of interstitial compounds are mutually soluble. Consequently, transition metal carbides with a broad range of metal contents are possible. Carbides may contain Group IV to Group VIII transition metals. Many of these materials may exist in the eta-phase structure with the metals on a cubic lattice and the non-metal atoms in octahedral interstitial sites. The incorporation of more than one metal atom type can result in significant improvements in performance.

Hydrogen electrodes 20 as used in the PEM fuel cell of the present invention are generally comprised of a gas diffusion layer 23 and an active material layer 24 supported by a conductive substrate 25. The gas diffusion layer 23 is designed to promote uniform hydrogen distribution across the face of the hydrogen electrode and absorption of the hydrogen into the active material layer, while the active material layer 24 is designed to receive and oxidize hydrogen providing hydrogen ions which are provided to the oxygen electrode.

The gas diffusion layer 23 of the hydrogen electrode is comprised a carbon matrix composed of carbon particles coated with polytetrafluoroethylene. The polytetrafluoroethylene acts as a barrier means to isolate the electrolyte, or wet, side of the hydrogen electrode from the gaseous, or dry, side of the hydrogen electrode. Materials other than polytetrafluoroethylene may be mixed with the carbon particles in the gas diffusion layer to isolate the dry side of the electrode from the wet side of the electrode, providing the materials allow for the flow of hydrogen gas through the gas diffusion layer to the active material layer while preventing the flow of liquid therethrough. The carbon particles may be carbon black known as Vulcan XC-72 carbon (Trademark of Cabot Corp.), which is well known in the art. The gas diffusion layer may contain approximately 20-60 percent by weight polytetrafluoroethylene with the remainder consisting of carbon particles. The use of carbon particles rather than materials like nickel in the gas diffusion layer allows the amount of polytetrafluoroethylene to vary as needed up to 60 weight percent without clogging the pores in the gas diffusion layer. The polytetrafluoroethylene concentration within the gas diffusion layer may also be continually graded from a high concentration at the side of the gas diffusion layer contacting the active material layer to a low concentration at the gas interface of the gas diffusion layer.

The active material layer 24 of the hydrogen electrode comprises an anode active material including the non-noble metal catalytic material supported on at least one conductive substrate. The anode active material may be comprised of 90 to 95 weight percent of non-noble metal catalytic material, 0.0 to 10 weight percent binder material, and 0.0 to 2.0 weight percent graphite or graphitized carbon. To increase conductivity between the hydrogen electrode 20 and the proton exchange membrane 40, Nafion® (Trademark of Dupont) or a material having similar properties may be added to the anode active material.

The cathode active material of the oxygen electrode 30 in accordance with the present invention comprises one or more non-noble metal catalysts catalytic toward the reduction of oxygen. Preferably, the oxygen electrode is substantially free from any noble metals. Such non-noble metal catalysts may also have oxygen storage capability via a change in the valency of the catalytic material.

One type of non-noble metal catalysts for use in the cathode active material of the oxygen electrode of the present invention are metal carbides including at least one transition metal element. Certain transition metal carbides such as tungsten and molybdenum carbides are highly conductive, catalytically active, and stable in an acidic environment. The high surface carbides will be in the form of nano-particles with surface areas in the range of 150 to 300 m²/g. The metal carbides may include modified elements, such as boron or silicon. The modifier elements may be incorporated into the carbide as part of a sputtering target or the reactive atmosphere when forming the carbide. Modifier elements such as boron or silicon are “glass formers”, which will cause the resultant carbides to be amorphous and possess unique properties. The modifier elements cause the transition metal carbides to have greater stability and lower solubility in the acidic environment.

Another type of non-noble metal catalysts for use in the cathode active material of the oxygen electrode of the present invention are pyrolized macrocyclics and certain transition metal oxides. While macrocyclics are generally not stable above temperatures of 60° C., they may be stabilized with metal oxides. Three groups of metal oxides suitable for oxygen reduction catalysts in the oxygen electrode are perovskites, spinels, and pyrochlores. Perovskites are transition metal oxides with substituted perovskitic structure. The perovskitic structure is shown as A₁₋ₓA′ₓBO₃, where A is a lanthanide, A′ is an alkaline earth metal, and B is a first row transition metal. The addition of the A′ ion is necessary to give sufficient conductivity for most of the compounds. An example of a perovskite is LaCoO₃ doped with Sr to improve its electrical conductivity. Pyrochlores may be described as A₂B₂₋ₓAxOO′ where A is a rare earth element (Nd, Dy, Y), or an element such as Ti, Pb, or Bi, B is usually a transition metal, and O and O′ are crystallographically distinct types of oxygen. The pyrochlores have shown high kinetic activity and excellent kinetics for the oxygen reduction reaction. Spinels are mixed oxides with a general formula of AB₂O₄, where A is a nonmagnetic metal and B is a transition metal. All A metal ions lie on equivalent sites of the unit cell of the spinel structure, each of which is a lattice point at the center of a tetrahedron of anions. All B ions are found at lattice points at the center of an octahedron of anions. Neighboring pairs of B ions are ferro-magnetically bonded. Spinels such as LiNi₂O₄ and NiCo₂O₄ have been found to have excellent catalytic activity with their conductivities being increased by the addition of Cu and Mn. Another type of non-noble metal catalysts for use in the cathode active material of the oxygen electrode of the present invention are titanium oxide based materials. Titanium oxides are acid resistant and catalytic toward the reduction of oxygen. Titanium may form oxides comprising one or more sub-oxides having different conductivities. For example, Ti forms an oxide comprised of multiple sub-oxides having different conductivities. Titanium sub-oxides having the formula TiOₓ, with 0.65≦x≦1.25 have high conductivities and are preferred for use in the present invention.

Oxygen electrodes as used in the PEM fuel cell of the present invention are generally comprised of a gas diffusion layer 33 and an active material layer 34 supported on a conductive substrate 35. The gas diffusion layer 33 is designed to promote uniform oxygen distribution across the oxygen interface 31 of the oxygen electrode 30 and into the active material layer 34, while the active material layer is designed to receive and reduce oxygen to form water.

The gas diffusion layer 33 is composed of a teflonated carbon matrix. The polytetrafluoroethylene acts as a barrier means to isolate the electrolyte, or wet, side of the hydrogen electrode from the gaseous, or dry, side of the hydrogen electrode. Materials other than polytetrafluoroethylene may be mixed with the carbon particles in the gas diffusion layer to isolate the dry side of the electrode from the wet side of the electrode, providing the materials allow for the flow of oxygen gas through the gas diffusion layer to the active material layer while preventing the flow of liquid therethrough. The teflonated carbon matrix may be comprised of 40% teflonated acetylene black carbon or 60% teflonated Vulcan XC-72 carbon (Trademark of Cabot Corp.).

The active material layer 34 of the oxygen electrode 30 is comprised of a cathode active material including the non-noble metal catalytic material catalytic toward the reduction of oxygen. The cathode active material may be comprised of 90 to 95 weight percent of the non-noble metal catalytic material, 0.0 to 2.0 weight percent carbon, 5.0 to 10 weight percent binder material, and 0.0 to 5.0 weight percent graphite or graphitized carbon. To increase conductivity between the oxygen electrode 30 and the proton exchange membrane 40, Nafion® (Trademark of Dupont) or a material having similar properties may be added to the cathode active material. The carbon particles are preferably carbon black particles, such as Black Pearl 2000® (Trademark of Cabot Corp.).

The electrodes in accordance with the present invention may be paste-type electrodes or non paste-type electrodes. Non-paste type electrodes may be powder compacted, sintered chemically/electrochemically impregnated, or plastic bonded extruded type. Paste-type electrodes may be formed by applying a paste of the active electrode material onto a conductive substrate, compressing a powdered active electrode material onto a conductive substrate, or by forming a ribbon of the active electrode material and affixing it onto a conductive substrate. The conductive substrate may be any electrically conductive support structure selected from, but not limited to, an electrically conductive mesh, grid, foam, expanded metal, or combinations thereof. The most preferable conductive substrate is an electrically conductive mesh having 40 wires per inch horizontally and 20 wires per inch vertically, although other meshes may work equally well. The wires comprising the mesh may have a diameter between 0.005 inches and 0.01 inches, preferably between 0.005 inches and 0.008 inches. This design provides optimal current distribution due to the reduction of the ohmic resistance. Where more than 20 wires per inch are vertically positioned, problems may be encountered when affixing the active material to the substrate. The actual form of the substrate used may depend on whether the substrate is used for the positive or the negative electrode of the electrochemical cell, the type of active material used, and whether it is paste type or non-paste type electrode. The conductive substrate may be formed of any electrically conductive material and is preferably formed of a metallic material such as a pure metal or a metal alloy. Examples of materials that may be used include nickel, nickel alloy, copper, copper alloy, nickel-plated metals such as nickel-plated copper and copper-plated nickel. The actual material used for the substrate depends upon many factors including whether the substrate is being used for the hydrogen or oxygen electrode, the potential of the electrode, and the pH of the electrolyte as used in the fuel cell.

In a paste type electrode, the active electrode composition is first made into a paste. This may be done by first making the active electrode composition into a paste, and then applying the paste onto a conductive substrate. A paste may be formed by adding water and a “thickener” such as carboxymethyl cellulose (CMC) or hydroxypropylmethyl cellulose (HPMC) to the active composition. The paste would then be applied to the substrate. After the paste is applied to the substrate to form the electrode, the electrode may be sintered. The electrode may optionally be compressed prior to sintering.

To form the electrodes by compressing the powdered active electrode material onto the substrate, the active electrode material is first ground together to form a powder. The powdered active electrode material is then pressed or compacted onto a conductive substrate. After compressing the powdered active electrode material onto the substrate, the electrode may be sintered. To form the electrodes using ribbons of the active electrode material, the active electrode material is first is ground into a powder and placed into a roll mill. The roll mill preferably produces a ribbon of the active electrode material having a thickness ranging from 0.018 to 0.02 inches, however, ribbons with other thicknesses may be produced in accordance with the present invention. Once the ribbon of the active electrode material has been produced, the ribbon is placed onto a conductive substrate and rerolled in the roll mill to form the electrode. After being rerolled, the electrode may be sintered.

The electrode may be sintered in the range of 170 to 180° C. so as not to decompose the conductive polymer, as compared to sintering temperatures in the range of 310 to 330° C. if the conductive polymer is not utilized in the electrode.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A PEM fuel cell comprising:
a hydrogen electrode including an anode active material including a non-noble metal hydrogen oxidation catalyst and/or an oxygen electrode including a cathode active material including a non-noble metal oxygen reduction catalyst.

2. The PEM fuel cell according to claim 1, wherein said non-noble metal hydrogen oxidation catalyst comprises a hydrogen storage alloy.

3. The PEM fuel cell according to claim 2, wherein said hydrogen storage alloy is selected from Rare-earth metal alloys, Misch metal based alloys, zirconium based alloys, titanium based alloys, magnesium/nickel based alloys, tantalum based alloys, tungsten based alloys, and mixtures thereof.

4. The PEM fuel cell according to claim 2, wherein said hydrogen storage alloy is at least partially coated with an acid resistant coating.

5. The PEM fuel cell according to claim 4, wherein said acid resistant comprises one or more selected from metals, metal oxides, metal carbides, nitrides, and fluoropolymers.

6. The PEM fuel cell according to claim 1, wherein said non-noble metal hydrogen oxidation catalyst comprises a high surface area carbide including at least one transition metal.

7. The PEM fuel cell according to claim 6, wherein said high surface area carbide includes tungsten and/or molybdenum.

8. The PEM fuel cell according to claim 7, wherein said high surface area carbide has a surface area of 150 m²/g to 300 m²/g.

9. The PEM fuel cell according to claim 1, wherein said hydrogen electrode is substantially free of noble metals.

10. The PEM fuel cell according to claim 9, wherein said non-noble metal oxygen reduction catalyst comprises a high surface area carbide including at least one transition metal.

11. The PEM fuel cell according to claim 10, wherein said high surface area carbide includes tungsten and/or molybdenum.

12. The PEM fuel cell according to claim 11, wherein said high surface area carbide has a surface area of 150 m²/g to 300 m²/g.

13. The PEM fuel cell according to claim 9, wherein said non-noble metal oxygen reduction catalyst comprises at least one metal oxide selected from perovskites, spinels, and pyrochlores.

14. The PEM fuel cell according to claim 13, wherein said perovskites have the formula A₁₋ₓA′ₓBO₃, wherein A is a lanthanide, A′ is an alkaline earth metal, and B is a first row transition metal.

15. The PEM fuel cell according to claim 13, wherein said pyrochlores have the formula A₂B₂₋ₓAₓOO, wherein A is a rare earth element, Ti, Pb, or Bi, and B is a transition metal.

16. The PEM fuel cell according to claim 13, wherein said spinels have the formula AB₂O₄, wherein A is a nonmagnetic metal and B is a transition metal.

17. The PEM fuel cell according to claim 9, wherein said non-noble metal oxygen reduction catalyst comprises one or more titanium suboxides having the formula TiOₓ, wherein 0.65≦X≦1.25.

18. The PEM fuel cell according to claim 1, wherein said oxygen electrode is substantially free of noble metals.

19. A PEM fuel cell comprising:
a hydrogen electrode including an anode active material substantially free of noble metals.

20. A PEM fuel cell comprising:
an oxygen electrode including a cathode active material substantially free of noble metals.
